(19) United States
(12) Patent Application Publication
(10) Pub. No.: US 2024/0076859 A1
(43) Pub. Date: Mar. 7, 2024

(54) PULL-OUT AUTOMATIC FAUCET

(71) Applicant: Xiamen Forbetter Sanitary Ware Co., Ltd., Xiamen (CN)

(72) Inventors: Xiliang Yan, Xiamen (CN); Yihui Chen, Xiamen (CN); Mouyong Lin, Xiamen (CN)

(21) Appl. No.: 17/938,901

(22) Filed: Sep. 6, 2022

(51) Int. Cl. E03C 1/05; F16K 11/00; F16K 31/06; F16L 27/12

(52) U.S. Cl. CPC E03C 1/057; F16K 19/006; F16K 31/0603; F16L 27/12

(57) ABSTRACT

A pull-out automatic faucet includes a faucet body, an integrated valve seat, a solenoid valve, a water-mixing valve core, a pull-out spray head, a pull-out tube having two ends respectively connected to the pull-out spray head and the integrated valve seat, and a sensor electrically connected to the solenoid valve. The integrated valve seat is insertedly disposed in a main pipe and a branch pipe of the faucet body. The solenoid valve is mounted to the integrated valve seat. The water-mixing valve core is connected to the integrated valve seat. The pull-out tube is movably inserted through the main pipe. The pull-out automatic faucet has a compact structure. The faucet body is small in size.

### 1. BACKGROUND OF THE INVENTION

### Field of the Invention

The present invention relates to a kitchen faucet, and more particularly to a pull-out automatic faucet.

### 2. DESCRIPTION OF THE PRIOR ART

Faucets are widely used in kitchens, bathrooms, etc., as essential equipment for our daily life. A pull-out faucet is widely used because its pull-out spray head can be pulled and moved to meet the needs of different locations for washing. The pull-out faucet is easy to use.

In order to improve the convenience and hygiene of the pull-out faucets, some pull-out faucets are equipped with sensors and solenoid valves to achieve a sensor-operated spray mode. This pull-out faucet having a sensor and a solenoid valve is called a pull-out automatic faucet.

In the existing pull-out automatic faucet, because the faucet body needs to provide a space for movement of the pull-out tube, the solenoid valve is separated from the faucet body to prevent the solenoid valve from occupying the internal space of the faucet body.

In order to improve the integrity of the pull-out automatic faucet, the solenoid valve may be mounted in the faucet body. For example, as disclosed in Chinese Patent Publication No. CN113531190A, the automatic faucet has a solenoid valve mounted in the faucet body. However, in this automatic faucet, the solenoid valve is first mounted to the integrated valve seat, and then the solenoid valve and the integrated valve seat are mounted together from the branch pipe on the side of the faucet body into the faucet body. The solenoid valve is mounted to the upper side of the integrated valve seat so that the solenoid valve can give way to the pull-out tube. However, this will lead to a larger installation space of the branch pipe for the solenoid valve and the integrated valve seat. The inner diameter of the branch pipe must be large so that the integrated valve seat and the solenoid valve mounted on the integrated valve seat can be fitted into the faucet body from the branch pipe on the side of the faucet body. If the inner diameter of the branch pipe is large, the material used for the branch pipe is much, the cost is high, and the shape of the faucet body is unsightly.

### SUMMARY OF THE INVENTION

The primly object of the present invention is to provide a pull-out automatic faucet, which can overcome the deficiencies of the prior art.

In order to achieve the above object, the present invention adopts the following solutions.

A pull-out automatic faucet comprises a faucet body, a waterway control assembly, a pull-out tube, a pull-out spray head, and a sensor. The faucet body includes a main pipe having upper and lower openings and a branch pipe connected to a side wall of the main pipe. The branch pipe communicates with the main pipe. An inner wall of the branch pipe is formed with a connecting edge. The waterway control assembly includes an integrated valve seat, a solenoid valve, and a water-mixing valve core. The integrated valve seat is inserted in the main pipe. The integrated valve seat is locked to the connecting edge with screws. The integrated valve seat has a cold water inlet, a hot water inlet, and a mixed water outlet. The cold water inlet, the hot water inlet and the mixed water outlet face downward. The integrated valve seat has a sensor-operated water chamber with an opening facing upward. The integrated valve seat further has a cold water aperture, a hot water aperture, and a mixed water aperture. The cold water aperture, the hot water aperture and the mixed water aperture extend towards a same side of the integrated valve seat. The cold water aperture and the hot water aperture communicate with the cold water inlet and the hot water inlet, respectively. The mixed water aperture communicates with the mixed water outlet via the sensor-operated water chamber. The solenoid valve is mounted to an upper portion of the integrated valve seat and closes the opening of the sensor-operated water chamber. The solenoid valve is located in the main pipe. A valve head of the solenoid valve extends into the sensor-operated water chamber and controls the mixed water aperture to communicate with the mixed water outlet or not. The water-mixing valve core is accommodated in the branch pipe. A cold water inlet end, a hot water inlet end and a mixed water outlet end of the water-mixing valve core are connected to the cold water aperture, the hot water aperture and the mixed water aperture of the integrated valve seat, respectively. The pull-out tube is movably inserted through the main pipe of the faucet body. An inlet end of the pull-out tube is connected to the mixed water outlet of the integrated valve seat. An outlet end of the pull-out tube is connected to the pull-out spray head. The sensor is electrically connected to the solenoid valve. The sensor is configured to control the solenoid valve to be actuated or not and further to control the mixed water aperture to communicate with the mixed water outlet or not.

Preferably, a bottom of the sensor-operated water chamber is formed with a sensor-operated outlet and a sensor-operated inlet. The sensor-operated outlet and the sensor-operated inlet communicate with the mixed water outlet and the mixed water aperture, respectively. The valve head of the solenoid valve faces the sensor-operated outlet and movably blocks the sensor-operated outlet.

Preferably, an annular valve cover is fitted at an opening of the branch pipe of the faucet body. The valve cover presses the water-mixing valve core.

Preferably, the integrated valve seat has a positioning hole, and the water-mixing valve core has a positioning post to be inserted into the positioning hole.

Preferably, the pull-out automatic faucet further comprises a spring spout and a support frame. A first end of the spring spout and a first end of the support frame are connected to the main pipe of the faucet body. The support frame includes a positioning portion for positioning the pull-out spray head. The pull-out tube is movably inserted through the main pipe and the spring spout.

Preferably, the positioning portion of the support frame is an elastic clip.

Preferably, a restricting cylinder is fixedly connected to the pull-out tube. The restricting cylinder is configured to stop and cooperate with a second end of the spring spout so as to restrict the pull-out tube.

Preferably, a restricting sleeve is fitted on the second end of the spring spout. The restricting sleeve movably abuts against the restricting cylinder.

Preferably, the second end of the spring spout is threadedly engaged with the restricting sleeve.

Preferably, the first end of the spring spout and the first end of the support frame are connected to the main pipe of the faucet body through a rotating pipe. The rotating pipe is rotatably connected to the main pipe. The rotating pipe is fixedly connected to the first end of the spring spout and the first end of the support frame.

With the above solutions, the integrated valve seat and the solenoid valve 22 of the present invention are located in the main pipe of the faucet body, and the integrated valve seat is locked to the connecting edge of the branch pipe of the faucet body by screws. In this way, in the present invention, when the integrated valve seat and the solenoid valve are to be mounted in the faucet body, the solenoid valve is first mounted to the integrated valve seat, and then the integrated valve seat and the solenoid valve are placed into the main pipe from the lower opening of the main pipe of the faucet body. Finally, the screws are screwed from the branch pipe of the faucet body for locking the integrated valve seat to the connecting edge of the branch pipe. In the present invention, there is no need for the solenoid valve to pass through the branch pipe when the integrated valve seat and the solenoid valve are to be mounted in the faucet body, thereby reducing the space required for the installation of the integrated valve seat and the solenoid valve relative to the branch pipe. The inner diameter of the branch pipe does not need to be enlarged, which is beneficial to reduce the material and cost of the branch pipe. The size of the faucet body is about equal to that of the existing pull-out faucet.

### BRIEF DESCRIPTION OF THE DRAWINGS

FIG. 1 is a perspective view of the present invention;

FIG. 2 is an exploded view of the present invention;

FIG. 3 is a first perspective view of the integrated valve seat of the present invention;

FIG. 4 is a second perspective view of the integrated valve seat of the present invention;

FIG. 5 is a third perspective view of the integrated valve seat of the present invention;

FIG. 6 is a perspective view of the water-mixing valve core of the present invention;

FIG. 7 is a first cross-sectional view of the present invention;

FIG. 8 is a second cross-sectional view of the present invention;

FIG. 9 is a third cross-sectional view of the present invention; and

FIG. 10 is a fourth cross-sectional view of the present invention.

### DETAILED DESCRIPTION OF THE PREFERRED EMBODIMENTS

Embodiments of the present invention will now be described, by way of example only, with reference to the accompanying drawings.

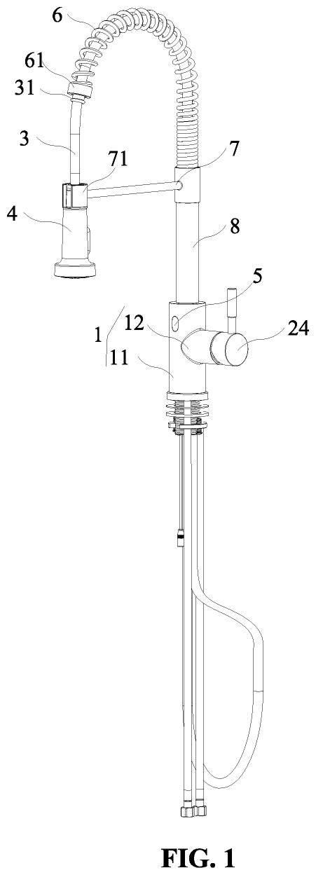

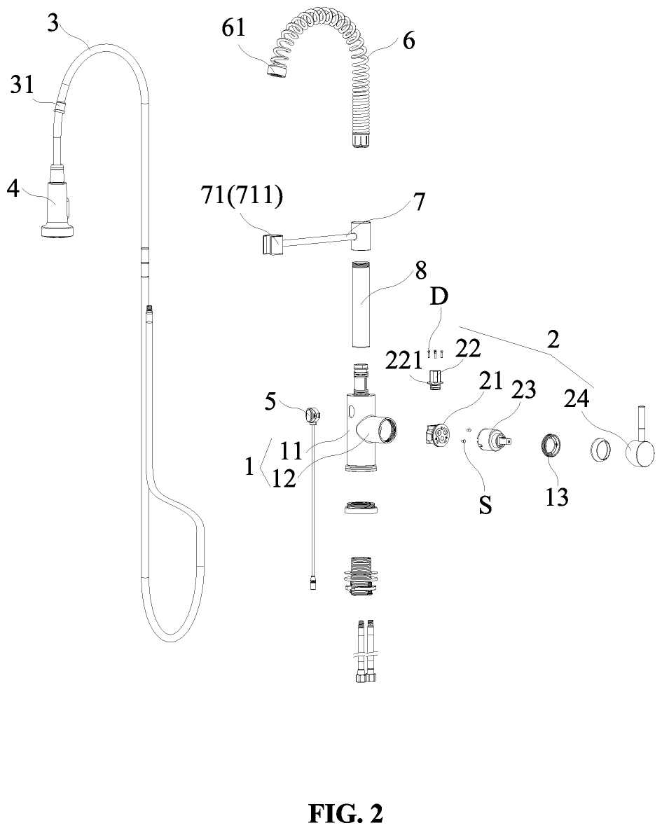

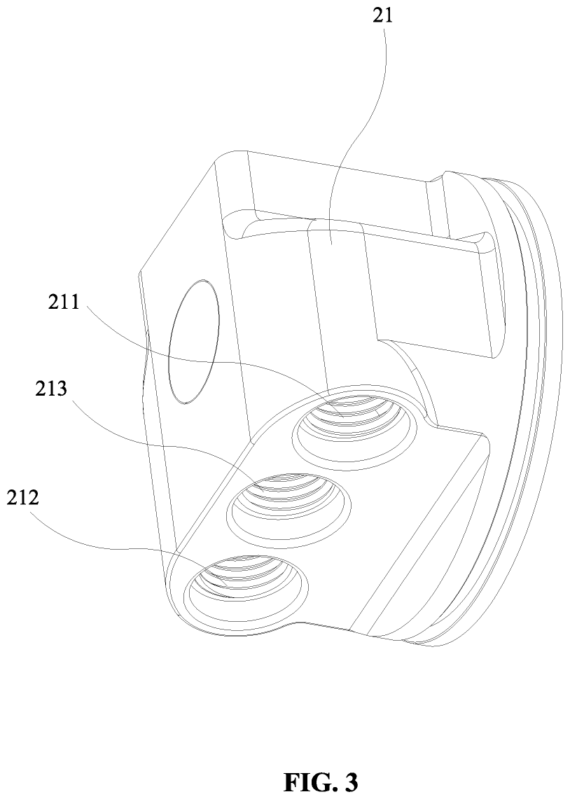

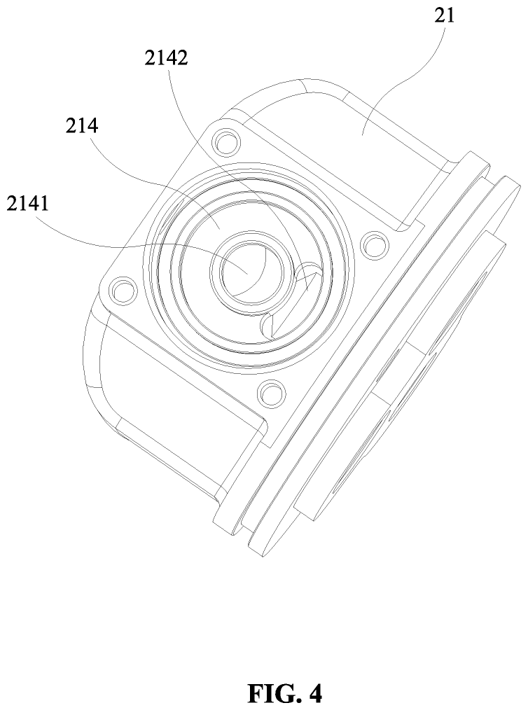

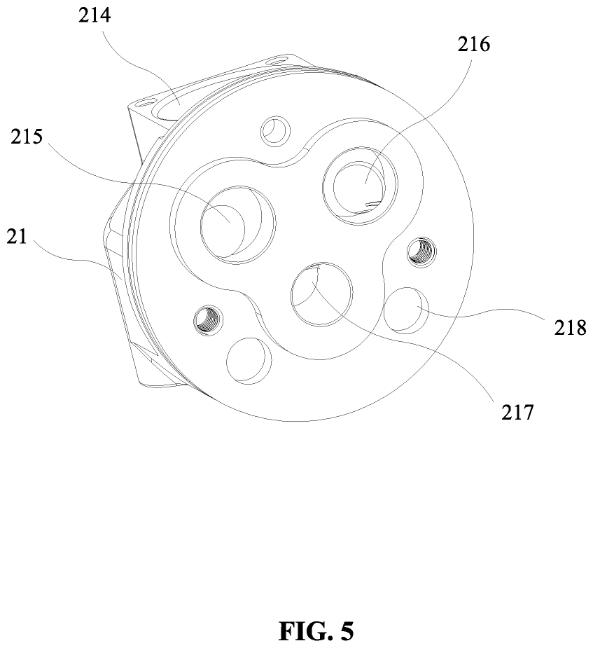

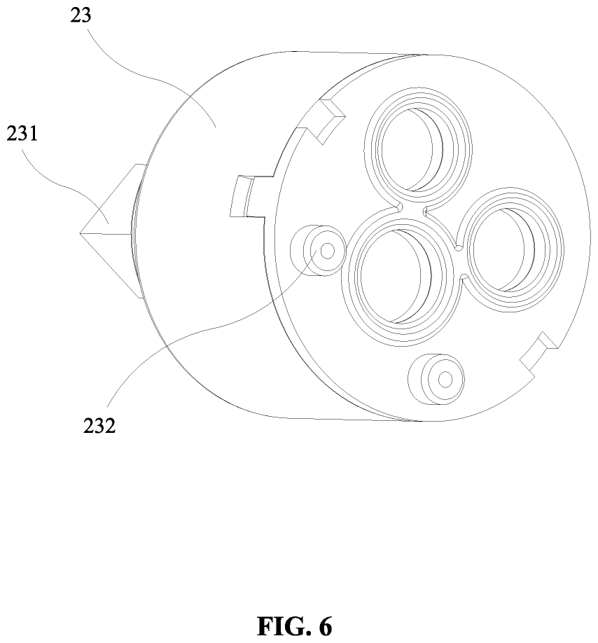

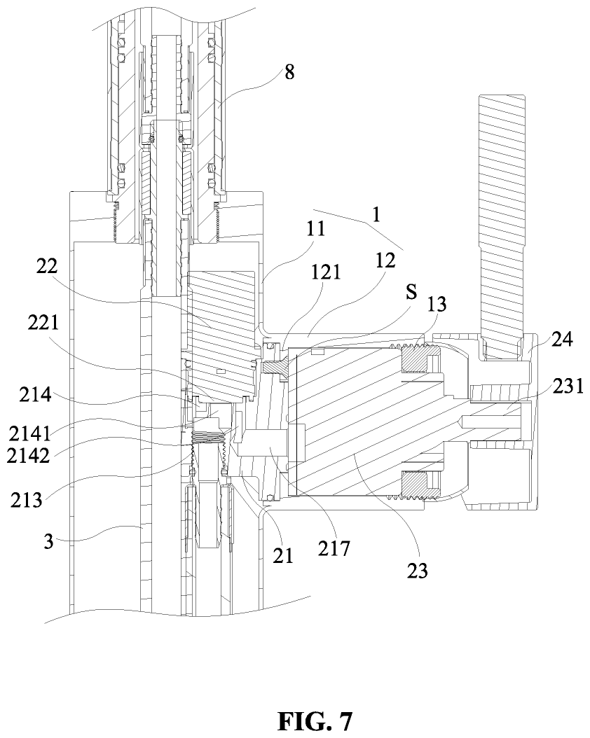

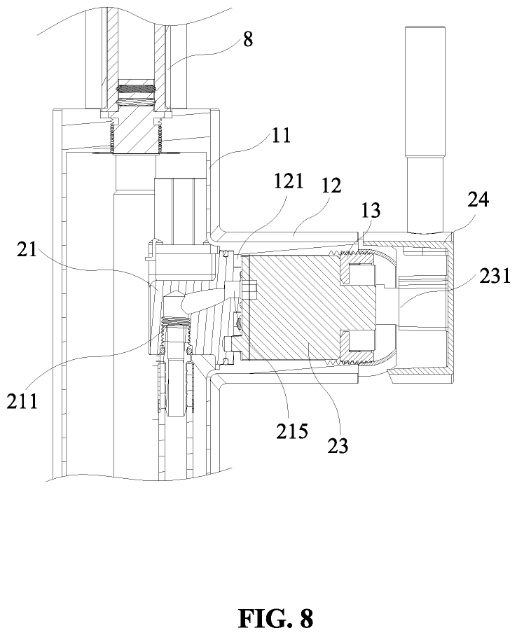

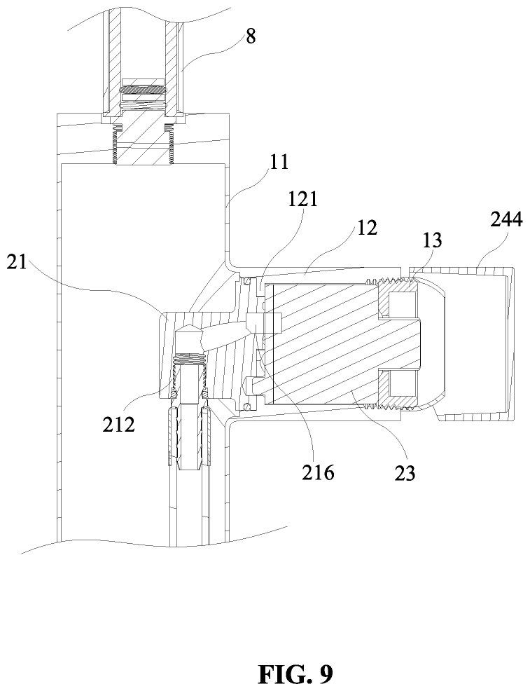

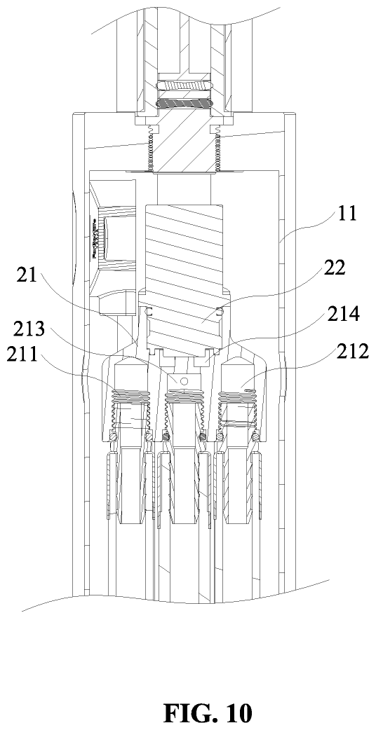

Referring to FIG. 1 through FIG. 10, the present invention discloses a pull-out automatic faucet, comprising a faucet body 1, a waterway control assembly 2, a pull-out tube 3, a pull-out spray head 4, and a sensor 5. The faucet body 1 includes a main pipe 11 having upper and lower openings and a branch pipe 12 connected to the side wall of the main pipe 11. The branch pipe 12 communicates with the main pipe 11. A connecting edge 121 is formed on the inner wall of the branch pipe 12. The waterway control assembly 2 includes an integrated valve seat 21, a solenoid valve 22, and a water-mixing valve core 23. The integrated valve seat 21 is inserted in the main pipe 11, and the integrated valve seat 21 is locked to the connecting edge 121 with screws. The integrated valve seat 21 has a cold water inlet 211, a hot water inlet 212 and a mixed water outlet 213. The cold water inlet 211, the hot water inlet 212 and the mixed water outlet 213 face downward. The integrated valve seat 21 further has a sensor-operated water chamber 214 with an opening facing upward. The integrated valve seat 21 further has a cold water aperture 215, a hot water aperture 216 and a mixed water aperture 217. The cold water aperture 215, the hot water aperture 216 and the mixed water aperture 217 extend towards the same side of the integrated valve seat 21. The cold water aperture 215 and the hot water aperture 216 communicate with the cold water inlet 211 and the hot water inlet 212, respectively. The mixed water aperture 217 communicates with the mixed water outlet 213 via the sensor-operated water chamber 214. The solenoid valve 22 is mounted to the upper portion of the integrated valve seat 21 and closes the opening of the sensor-operated water chamber 214. The solenoid valve 22 is located in the main pipe 11. A valve head 221 of the solenoid valve 22 extends into the sensor-operated water chamber 214 and controls the mixed water aperture 217 to communicate with the mixed water outlet 213 or not. The water-mixing valve core 23 is accommodated in the branch pipe 12. A cold water inlet end, a hot water inlet end and a mixed water outlet end of the water-mixing valve core 23 are connected to the cold water aperture 215, the hot water aperture 216 and the mixed water aperture 217 of the integrated valve seat 21, respectively. The pull-out tube 3 is movably inserted through the main pipe 11 of the faucet body 1. An inlet end of the pull-out tube 3 is connected to the mixed water outlet 213 of the integrated valve seat 21. An outlet end of the pull-out tube 3 is connected to the pull-out spray head 4. The sensor 5 is electrically connected to the solenoid valve 22. The sensor 5 is configured to control the solenoid valve 22 to be actuated or not and further to control the mixed water aperture 217 to communicate with the mixed water outlet 213 or not, so as to control the pull-out spray head 4 to discharge water or not.

In the present invention, the integrated valve seat 21 and the solenoid valve 22 of the present invention are located in the main pipe 11 of the faucet body 1, and the integrated valve seat 21 is locked to the connecting edge 121 of the branch pipe 12 of the faucet body 1 by screws. In this way, in the present invention, when the integrated valve seat 21 and the solenoid valve 22 are to be mounted in the faucet body 1, the solenoid valve 22 is first mounted to the integrated valve seat 21, and then the integrated valve seat 21 and the solenoid valve 22 are placed into the main pipe 11 from the lower opening of the main pipe 11 of the faucet body 1. Finally, the screws S are screwed from the branch pipe 12 of the faucet body 1 for locking the integrated valve seat 21 to the connecting edge 121 of the branch pipe 12. In the present invention, there is no need for the solenoid valve 22 to pass through the branch pipe 12 when the integrated valve seat 21 and the solenoid valve 22 are to be mounted in the faucet body 1, thereby reducing the space required for the installation of the integrated valve seat 21 and the solenoid valve 22 relative to the branch pipe 12. The inner diameter of the branch pipe 12 does not need to be enlarged, which is beneficial to reduce the material and cost of the branch pipe 12. The size of the faucet body 1 is about equal to that of the existing pull-out faucet, which is more in line with the consumption concept of consumers. In addition, the cold water inlet 211, the hot water inlet 212 and the mixed water outlet 213 of the integrated valve seat 21 face downward, which can reduce the occupation of the lateral space inside the main pipe 11 of the faucet body 1 when the cold water inlet 211 and the hot water inlet 212 are connected to an external water source via water pipes. The solenoid valve 22 is mounted to the upper portion of the integrated valve seat 21, so as to reduce the occupation of the lateral space inside the main pipe 11 of the faucet body 1.

In the present invention, the connecting edge 121 of the inner wall of the branch pipe 12 of the faucet body 1 may be close to the junction of the branch pipe 12 and the main pipe 11. The integrated valve seat 21 has screw holes for connection of the screws S. The connecting edge 121 has through holes for the screws S to pass through.

In the present invention, an annular valve cover 13 is fitted at the opening of the branch pipe 12 of the faucet body 1. The valve cover 13 presses the water-mixing valve core 23 and confines the water-mixing valve core 23 in the branch pipe 12, thereby preventing the water-mixing valve core 23 from coming out, so that the water-mixing valve core 23 is firmly connected to the integrated valve seat 21. The cold water inlet end, the hot water inlet end and the mixed water outlet end of the water-mixing valve core 23 may be fitted with sealing rings respectively, so that the cold water inlet end, the hot water inlet end and the mixed water outlet end of the water-mixing valve core 23 are connected to the cold water aperture 215, the hot water aperture 216 and the mixed water aperture 217 of the integrated valve seat 21 in a sealing manner, respectively. A valve stem 231 of the water-mixing valve core 23 passes through the valve cover 13, and the valve stem 231 of the water-mixing valve core 23 is connected to an operating handle 24 for the user to operate the water-mixing valve core 23. The integrated valve seat 21 has a positioning hole 218. The water-mixing valve core 23 has a positioning post 232 to be inserted into the positioning hole 218. The cooperation of the positioning post 232 and the positioning hole 218 enables the water-mixing valve core 23 and the integrated valve seat 21 to be connected accurately.

In the present invention, the integrated valve seat 21 may be manufactured by injection molding. The cold water inlet 211 intersects and communicates with the cold water aperture 215. The hot water inlet 212 intersects and communicates with the hot water aperture 216. The bottom of the sensor-operated water chamber 214 is formed with a sensor-operated outlet 2141 and a sensor-operated inlet 2142. The sensor-operated outlet 2141 and the sensor-operated inlet 2142 communicate with the mixed water outlet 213 and the mixed water aperture 217, respectively. The sensor-operated outlet 2141 and the mixed water outlet 213 are arranged in parallel and staggered. The sensor-operated inlet 2142 intersects and communicates with the mixed water aperture 217. The valve head 221 of the solenoid valve 22 faces the sensor-operated outlet 2141 and movably blocks the sensor-operated outlet 2141, so as to control the mixed water aperture 217 to communicate with the mixed water outlet 213 or not. The solenoid valve 22 may be locked to the integrated valve seat 21 with screws D.

In the present invention, the sensor 5 may be mounted on the main pipe 11 of the faucet body 1. The sensor 5 may be an infrared proximity sensor.

In the present invention, the pull-out automatic faucet of the present invention further comprises a spring spout 6 and a support frame 7. A first end of the spring spout 6 and a first end of the support frame 7 are connected to the main pipe 11 of the faucet body 1. The support frame 7 includes a positioning portion 71 for positioning the pull-out spray head 4. The pull-out tube 3 is movably inserted through the main pipe 11 and the spring spout 12. In this way, the pull-out automatic faucet of the present invention is a spring pull-out faucet. The spring spout 6 can be bent and deformed so that the movable range of the pull-out spray head 4 is wider. The positioning portion 71 of the support frame 7 is configured to position the pull-out spray head 4 so that the pull-out spray head 4 can be placed stably. The positioning portion 71 may be an elastic clip 711. The positioning portion 71 is disposed on a second end of the support frame 7.

In the present invention, a restricting cylinder 31 is fixedly connected to the pull-out tube 3. The restricting cylinder 31 is configured to stop and cooperate with a second end of the spring spout 6 so as to restrict the pull-out tube 3. The restricting cylinder 31 of the pull-out tube 3 stops and cooperates with the second end of the spring spout 6 to restrict the pull-out tube 3, which can prevent the pull-out tube 3 from returning excessively. Excessive return of the pull-out tube 3 means that the pull-out spray head 4 is not positioned by the support frame 7 when the pull-out spray head 4 is returned, which results in that the pull-out spray head 4 is brought closer to the second end of the spring spout 6 so that the pull-out tube 3 is returned excessively. A restricting sleeve 61 is fitted on the second end of the spring spout 6. The restricting sleeve 61 movably abuts against the restricting cylinder 31 so that the restricting cylinder 31 can stop and cooperate with the second end of the spring spout 6. The restricting sleeve 61 is engaged with the second end of the spring spout 6. In this way, the connection of the restricting sleeve 61 and the spring spout 6 is simple and stable.

In the present invention, the first end of the spring spout 6 and the first end of the support frame 7 are connected to the main pipe 11 of the faucet body 1 through a rotating pipe 8. The rotating pipe 8 is rotatably connected to the main pipe 11. The rotating pipe 8 is fixedly connected to the first end of the spring spout 6 and the first end of the support frame 7. In this way, the spring spout 6, the support frame 7 and the rotating pipe 8 can be rotated relative to the faucet body 1. It is convenient for the user to use the faucet.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A pull-out automatic faucet, comprising a faucet body, a waterway control assembly, a pull-out tube, a pull-out spray head, and a sensor;
the faucet body including a main pipe having upper and lower openings and a branch pipe connected to a side wall of the main pipe, the branch pipe communicating with the main pipe, an inner wall of the branch pipe being formed with a connecting edge;
the waterway control assembly including an integrated valve seat, a solenoid valve, and a water-mixing valve core; the integrated valve seat being inserted in the main pipe, the integrated valve seat being locked to the connecting edge with screws, the integrated valve seat having a cold water inlet, a hot water inlet and a mixed water outlet, the cold water inlet, the hot water inlet and the mixed water outlet facing downward, the integrated valve seat having a sensor-operated water chamber with an opening facing upward, the integrated valve seat further having a cold water aperture, a hot water aperture and a mixed water aperture, the cold water aperture, the hot water aperture and the mixed water aperture extending towards a same side of the integrated valve seat, the cold water aperture and the hot water aperture communicating with the cold water inlet and the hot water inlet respectively, the mixed water aperture communicating with the mixed water outlet via the sensor-operated water chamber; the solenoid valve being mounted to an upper portion of the integrated valve seat and closing the opening of the sensor-operated water chamber, the solenoid valve being located in the main pipe, a valve head of the solenoid valve extending into the sensor-operated water chamber and controlling the mixed water aperture to communicate with the mixed water outlet or not; the water-mixing valve core being accommodated in the branch pipe, a cold water inlet end, a hot water inlet end and a mixed water outlet end of the water-mixing valve core being connected to the cold water aperture, the hot water aperture and the mixed water aperture of the integrated valve seat, respectively;
the pull-out tube being movably inserted through the main pipe of the faucet body, an inlet end of the pull-out tube being connected to the mixed water outlet of the integrated valve seat, an outlet end of the pull-out tube being connected to the pull-out spray head;
the sensor being electrically connected to the solenoid valve, the sensor being configured to control the solenoid valve to be actuated or not and further to control the mixed water aperture to communicate with the mixed water outlet or not.

2. The pull-out automatic faucet as claimed in claim 1, wherein a bottom of the sensor-operated water chamber is formed with a sensor-operated outlet and a sensor-operated inlet, the sensor-operated outlet and the sensor-operated inlet communicate with the mixed water outlet and the mixed water aperture, respectively; the valve head of the solenoid valve faces the sensor-operated outlet and movably blocks the sensor-operated outlet.

3. The pull-out automatic faucet as claimed in claim 1, wherein an annular valve cover is fitted at an opening of the branch pipe of the faucet body, and the valve cover presses the water-mixing valve core.

4. The pull-out automatic faucet as claimed in claim 1, wherein the integrated valve seat has a positioning hole, and the water-mixing valve core has a positioning post to be inserted into the positioning hole.

5. The pull-out automatic faucet as claimed in claim 1, further comprising a spring spout and a support frame; a first end of the spring spout and a first end of the support frame being connected to the main pipe of the faucet body, the support frame including a positioning portion for positioning the pull-out spray head; the pull-out tube being movably inserted through the main pipe and the spring spout.

6. The pull-out automatic faucet as claimed in claim 5, wherein the positioning portion of the support frame is an elastic clip.

7. The pull-out automatic faucet as claimed in claim 6, wherein a restricting cylinder is fixedly connected to the pull-out tube, and the restricting cylinder is configured to stop and cooperate with a second end of the spring spout so as to restrict the pull-out tube.

8. The pull-out automatic faucet as claimed in claim 7, wherein a restricting sleeve is fitted on the second end of the spring spout, and the restricting sleeve movably abuts against the restricting cylinder.

9. The pull-out automatic faucet as claimed in claim 8, wherein the second end of the spring spout is threadedly engaged with the restricting sleeve.

10. The pull-out automatic faucet as claimed in claim 5, wherein the first end of the spring spout and the first end of the support frame are connected to the main pipe of the faucet body through a rotating pipe; the rotating pipe is rotatably connected to the main pipe, and the rotating pipe is fixedly connected to the first end of the spring spout and the first end of the support frame.
